(19) United States
(12) Patent Application Publication
(10) Pub. No.: US 2008/0185875 A1
(43) Pub. Date: Aug. 7, 2008

(54) Front-End Structure of a Motor Vehicle

(75) Inventors: Rainer Joest, Vaihingen an der Enz (DE); Joachim Kappich, Bad Liebenzell (DE); Matthias Herntier, Wurmberg (DE)

Correspondence Address: LERNER GREENBERG STEMER LLP, P O BOX 2480, HOLLYWOOD, FL, 33022-2480, US

(73) Assignee: DR. ING. H.C. F. PORSCHE AKTIENGESELLSCHAFT, Weissach (DE)

(21) Appl. No.: 12/027,623

(22) Filed: Feb. 7, 2008

(30) Foreign Application Priority Data
Feb. 7, 2007 (DE) 10 2007 006 031.0

(51) Int. Cl. B62D 25/08

(52) U.S. Cl. 296/203.02

(57) ABSTRACT

A front-end structure of a motor vehicle has a stiffening part which runs in the transverse direction of the vehicle. The stiffening part is in a form of a sheet-like cast part and is fixedly connected on each of the longitudinal end sides to a spring strut dome of the motor vehicle and on its longitudinal side to a cowl.

### CROSS-REFERENCE TO RELATED APPLICATION

This application claims the priority, under 35 U.S.C. § 119, of German application DE 10 2007 006 031.0, filed Feb. 7, 2007; the prior application is herewith incorporated by reference in its entirety.

### BACKGROUND OF THE INVENTION

### Field of the Invention

The present invention relates to a front-end structure of a motor vehicle having a stiffening part which runs in the transverse direction of the vehicle. The invention also relates to a motor vehicle equipped with such a front-end structure.

A front-end structure of the generic type is known from published, German patent application DE 41 10 553 A1, in the case of which a structural element, which is composed of a stiffening part with spring strut mountings integrally connected to both its ends, is used for the purpose of stiffening a motor vehicle body in the transverse direction. The structural element serves, in the region of its stiffening part, to form a wall region of a supporting member which runs transversely with respect to the motor vehicle body, the further wall regions of the supporting member being formed by a floor of an equipment space and also by a partition wall, which separate the equipment space from a space located in front of it. The stiffening part here is in the form of sheet metal.

Further front-end structures and stiffening parts are known, for example, from published, European application EP 1 400 437 A2 (corresponding to U.S. Pat. No. 6,773,057) and from German patent DE 14 55 679 (corresponding to U.S. Pat. No. 3,285,653).

### SUMMARY OF THE INVENTION

It is accordingly an object of the invention to provide a front-end structure of a motor vehicle that overcomes the above-mentioned disadvantages of the prior art devices of this general type, which is an improved embodiment distinguished in particular by increased torsional rigidity.

With the foregoing and other objects in view there is provided, in accordance with the invention, a front-end structure for a motor vehicle. The front-end structure includes a stiffening part running in a transverse direction of the motor vehicle. The stiffening part is a sheet-shaped cast part having longitudinal end sides each fixedly connected to a spring strut dome of the motor vehicle and a longitudinal side fixedly connected to a cowl of the motor vehicle.

The invention is based on the general idea of forming a stiffening part that runs in the transverse direction of the vehicle in a front-end structure of a motor vehicle. The stiffening part is a three-dimensional and sheet-like part, and fixedly connects the stiffening part to the motor vehicle on at least three of its sides. The stiffening part here is preferably in the form of a sheet-like cast part and is fixedly connected on each of the longitudinal end sides to a spring strut dome of the motor vehicle and on its longitudinal side or along its longitudinal side to a cowl. Furthermore, the stiffening part has bent portions and beveled portions which result in the formation of stiffening surfaces which run obliquely with respect to one another and impart high torsional rigidity and high flexural strength to the stiffening part. The fixed connection of the stiffening part along one of its longitudinal sides to a cowl, or a cowl support of the motor vehicle, as well as the fixed connection of the longitudinal ends of the stiffening part to the associated spring domes, connect the stiffening part fixedly to the body and stiffen the latter particularly effectively, on the one hand by the fixed connection, and on the other hand by the high intrinsic stiffness of the stiffening part.

The stiffening part is expediently formed from a light metal alloy, in particular from a cast aluminum alloy. In this case, the aluminum is provided with specific and precisely predefined properties, for example by the addition of various alloying elements. Examples of these properties include hardness, toughness and good machinability. Suitable alloying additives are, in particular, silicon and magnesium. A stiffening part produced from a light metal also provides, in addition to the high stiffness required, a low weight, which is of great importance, in particular, in the manufacture of sports cars.

The stiffening part is expediently in the form of a water box cover. The stiffening part thereby fulfills an additional function, that is to cover the water box, which normally has to be covered by an additional water box cover made of plastic. The water box cover that has been customary to date can thus be omitted, as a result of which the number of parts in the motor vehicle equipped with the stiffening part according to the invention can be reduced and, as a result, in particular, manufacturing and logistics costs can be reduced.

In a further advantageous embodiment of the solution according to the invention, the side of the stiffening part which points downward in the installed state has reinforcing ribs. These are preferably produced in one piece with the stiffening part and are integrally formed on the latter while it is being produced. Reinforcing ribs such as these have the major advantage of being able to considerably increase a bending moment of the stiffening part, without greatly influencing the weight of the stiffening part at the same time. In particular, it is also possible for the three-dimensional and planar stiffening part with the reinforcing ribs according to the invention to be made thinner and therefore more lightweight.

It goes without saying that the abovementioned features and the features still to be explained below can be used not only in the particular combination described, but also in other combinations or on their own, without departing from the scope of the present invention.

Other features which are considered as characteristic for the invention are set forth in the appended claims.

Although the invention is illustrated and described herein as embodied in a front-end structure of a motor vehicle, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, perspective view of a front-end structure of a motor vehicle according to the invention;

FIG. 2A is a diagrammatic, perspective view of the under side of a stiffening part according to the invention;

FIG. 2B is a diagrammatic, perspective view of a top side of the stiffening part;

FIG. 3 is a diagrammatic, sectional view through a region in which the stiffening part is connected to a spring strut dome; and

FIG. 4 is a diagrammatic, sectional view in the region in which the stiffening part is connected to a cow.

### DETAILED DESCRIPTION OF THE INVENTION

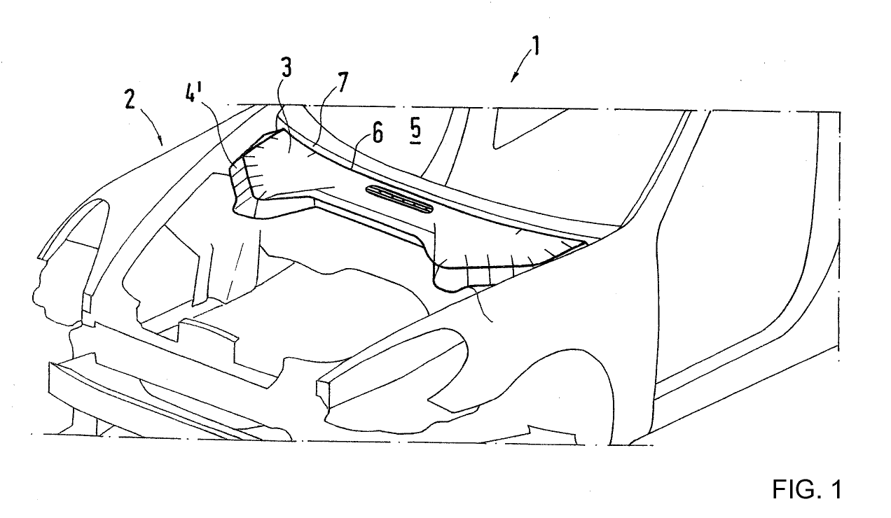

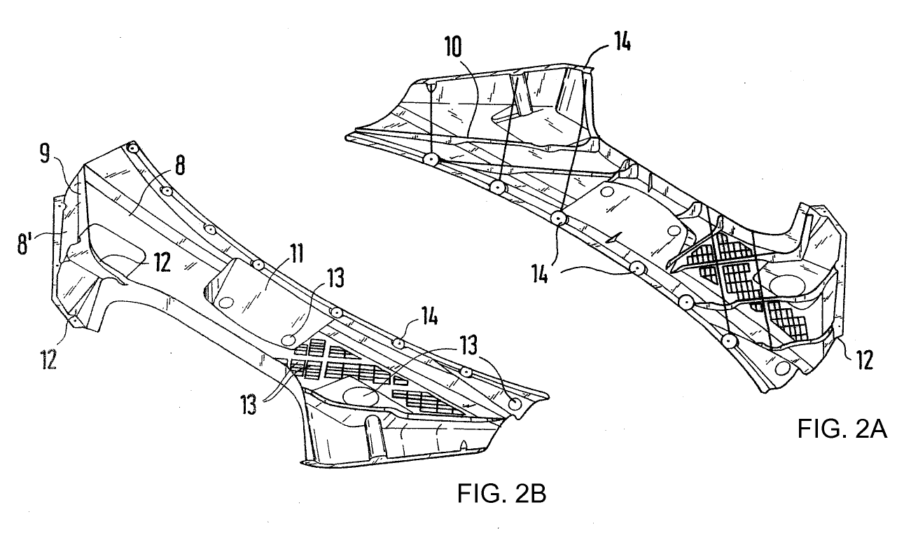

Referring now to the figures of the drawing in detail and first, particularly, to FIG. 1 thereof, there is shown a partially illustrated motor vehicle 1 that has, in a region of its front end 2, a stiffening part 3 which runs in the transverse direction of the vehicle. The stiffening part 3 is intended to stiffen the front end 2 of the motor vehicle 1 in particular in the transverse direction and against torsion. Such stiffening parts are usually in the form of cross-members and are fixedly connected, for example, at the longitudinal end sides to side members (not depicted in more detail) of a chassis of the motor vehicle 1. In contrast to this, the stiffening part 3 according to the invention is in the form of a sheet-like cast part (see also FIGS. 2A and 2B), and is fixedly connected at each longitudinal end side to a spring strut dome 4, 4′ of the motor vehicle 1 and, at a longitudinal side 6 facing toward a windshield 5, to a cowl 7. The connection between the stiffening part 3, on the one hand, and the spring strut domes 4, 4′ of the motor vehicle 1 and/or of the cowl 7, on the other hand, can be effected, for example, via screw-type connections, which permit simple exchange of the stiffening part 3 in the event of repair work being necessary.

It can further be seen from FIG. 1 that the stiffening part 3, in addition to its actual task, that is to stiffen the front-end structure of the motor vehicle 1, fulfills a further function, that is to cover a water box placed beneath the stiffening part 3. This cover has previously been realized by an additional water box cover usually produced from plastic, which can now be omitted. The stiffening part 3 according to the invention thus fulfills at least two functions.

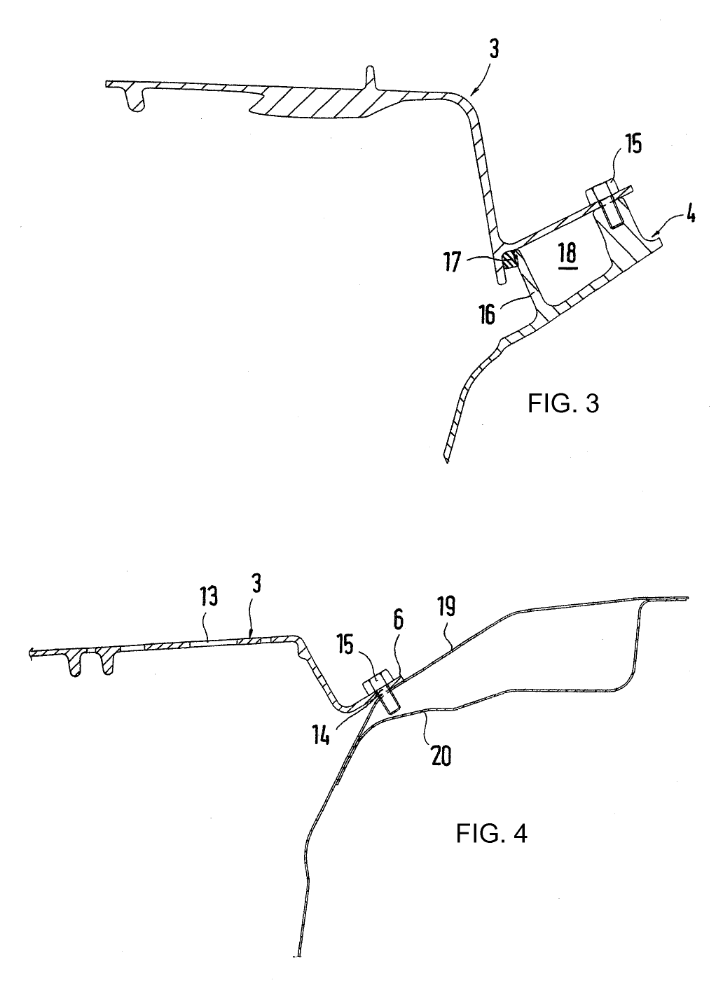

In accordance with FIG. 2A, an underside of the stiffening part 3, the underside pointing downward in the installed position of the stiffening part 3, is shown, whereas, in contrast, FIG. 2B illustrates the top side of the stiffening part 3, the top side being visible in the installed position. It can be seen that the stiffening part 3 is in the form of a three-dimensional sheet-like part having a wide variety of stiffening surfaces 8, 8′ which are disposed obliquely with respect to one another and are connected to one another by a beveled portion 9. In FIGS. 2A and 2B, the stiffening surfaces 8, 8′ and the beveled portion 9 are illustrated in purely exemplary fashion at just one point, and of course equally represent other stiffening surfaces (not depicted in more detail) of the stiffening part 3. The side of the stiffening part 3 which points downward in the installed state has reinforcing ribs 10 which, in accordance with FIG. 2A, are disposed in a manner such that they cross one another and form brass-like webs which increase the bending moment of the stiffening part 3. The reinforcing ribs 10 are preferably produced or formed in one piece together with the stiffening part 3. The reinforcing ribs 10 additionally make it possible to reduce the wall thickness of the remaining stiffening part 3, without having to accept losses in stiffness. In this case, it is apparent in accordance with FIG. 2A that at least some of the reinforcing ribs 10 connect screw openings 14 respectively placed on the edge side to one another, and thereby produce a direct web connection between individual screw openings 14. The stiffening part 3 is fixedly screwed either to the spring strut dome 4, 4′ or to the cowl 7 via the screw openings 14 using corresponding screws 15 (see FIGS. 3 and 4). Further features which increase the stiffness of the stiffening part 3 are, for example, a depression 11, as well as bent portions, folds and beads 12.

In accordance with FIGS. 2A and 2B, the stiffening part 3 has a plurality of through-openings 13 which permit, for example, access to a fuse box and/or to a brake fluid container and/or a feed-through of a wiper arm. Through-openings 13, which are formed and disposed with respect to one another in such a manner that a grid-like structure is produced, are also conceivable. The through-openings 13 are produced either directly during casting of the stiffening part 3 in the form of a cast part or by subsequent punching. As mentioned, the stiffening part 3 is in the form of a cast part, preferably in the form of a thin-walled cast part, in which case, in particular, use is made of a light metal alloy, for example a cast aluminum alloy. Such a cast aluminum alloy offers the major advantage that it is, on the one hand, lightweight, which is of great interest in particular in the manufacture of sports cars, but, on the other hand, is corrosion-resistant and can be subsequently machined easily, for example by chip-forming techniques. A suitable cast aluminum alloy is, for example, AlSi10Mg, a wall thickness of the thin-walled cast part being approximately from 1 to 3 mm, preferably 2.5 mm.

On account of its stiffness and strength, the stiffening part 3 can also be in the form of a support for a vehicle component such as, for example, a wiper system and/or an air inlet system.

FIG. 3 shows the connection of the stiffening part 3 to the spring strut dome 4, the sectional plane being located directly through the screw 15. In this case it is apparent that a seal 17 is disposed between the stiffening part 3 and a supporting rib 16 of the spring strut dome 4, the seal 17 being intended to prevent, for example, penetration of dirt and/or moisture into a hollow space 18.

FIG. 4 shows, in contrast, a sectional illustration in the region in which the longitudinal side 6 of the stiffening part 3 is connected to an end wall 19, which is connected, in particular welded, to a frame 20 of the cowl 7. In this case, preferably eight screw openings 14 are provided on the longitudinal side 6, whereas three screw openings 14 are provided on each of the longitudinal ends of the stiffening part 3.

It is generally applicable for the embodiments of the stiffening part 3 illustrated in accordance with FIGS. 1 to 4 that the arrangement or formation of through-openings 14, reinforcing ribs 10, depressions 11, bent portions, folds, beads 12 and/or through-openings 13 is illustrated purely by way of example, so that the invention is also intended to encompass stiffening parts 3 having differences which do not change the invention.

1. A front-end structure for a motor vehicle, the front-end structure comprising:
a stiffening part running in a transverse direction of the motor vehicle, said stiffening part being a sheet-shaped cast part having longitudinal end sides each fixedly connected to a spring strut dome of the motor vehicle and a longitudinal side fixedly connected to a cowl of the motor vehicle.

2. The front-end structure according to claim 1, wherein said stiffening part is formed from a light metal alloy.

3. The front-end structure according to claim 1, wherein said stiffening part is a water box cover.

4. The front-end structure according to claim 1, wherein said stiffening part is screwed to at least one of the spring strut domes of the motor vehicle and to the cowl.

5. The front-end structure according to claim 1, wherein said stiffening part has a side pointing downward in an installed state and reinforcing ribs disposed on said side pointing downward.

6. The front-end structure according to claim 1, wherein said stiffening part has at least one through-opening formed therein for permitting access to at least one of a fuse box, a brake fluid container, and a feed-through for a wiper arm.

7. The front-end structure according to claim 6, wherein said at least one through-opening is punched.

8. The front-end structure according to claim 1, wherein said stiffening part is a support for a vehicle component selected from the group consisting of a wiper system and an air inlet system.

9. The front-end structure according to claim 1, wherein said stiffening part is a thin-walled cast part.

10. The front-end structure according to claim 1, wherein said stiffening part is formed from a cast aluminum alloy.

11. A motor vehicle, comprising:
spring strut domes;
a cowl; and
a front-end structure having a stiffening part running in a transverse direction of the motor vehicle, said stiffening part being a sheet-shaped cast part having longitudinal end sides each fixedly connected to one of said spring strut domes and a longitudinal side fixedly connected to said cowl.

12. The motor vehicle according to claim 11, wherein said stiffening part is formed from a light metal alloy.

13. The motor vehicle according to claim 11, wherein said stiffening part is a water box cover.

14. The motor vehicle according to claim 11, wherein said stiffening part is screwed to at least one of said spring strut domes and to said cowl.

15. The motor vehicle according to claim 11, wherein said stiffening part has a side pointing downward in an installed state and reinforcing ribs disposed on said side pointing downward.

16. The motor vehicle according to claim 11, wherein said stiffening part has at least one through-opening formed therein permitting access to at least one of a fuse box, a brake fluid container, and a feed-through for a wiper arm.

17. The motor vehicle according to claim 16, wherein said at least one through-opening is punched.

18. The motor vehicle according to claim 11, wherein said stiffening part is a support for a vehicle component selected from the group consisting of a wiper system and an air inlet system.

19. The motor vehicle according to claim 11, wherein said stiffening part is a thin-walled cast part.

20. The motor vehicle according to claim 11, wherein said stiffening part is formed from a cast aluminum alloy.
